(19) United States
(12) Patent Application Publication
(10) Pub. No.: US 2022/0006371 A1
(43) Pub. Date: Jan. 6, 2022

(54) Permanent Magnet Motor

(71) Applicant: Hans Seternes, Trondheim (NO)

(72) Inventor: Hans Seternes, Trondheim (NO)

(21) Appl. No.: 17/293,722

(22) PCT Filed: Nov. 12, 2019
(86) PCT No.: PCT/NO2019/050247

§ 371 Date: May 13, 2021

(30) Foreign Application Priority Data
Nov. 17, 2018 (NO) 20181472

(51) Int. Cl. H02K 53/00

(52) U.S. Cl. CPC H02K 53/00

(57) ABSTRACT

Permanent magnet motor having a drive shaft connected to a power generator. At least a first power unit and a second power unit are arranged about the drive shaft, mutually delimited within the longitudinal axis of the drive shaft by a shielding plate. Each power unit exhibits a first rotary disc and a second rotary disc, mutually inclined with respect to the longitudinal axis of the drive shaft. A stator plate is arranged between the first and second rotary disc and exhibits a pull track along its periphery, and a push track on diametral opposite side of the rotary disk. At least six permanent magnet pairs having a pull magnet and a push magnet are arranged at an equal mutual distance along respective attachment circles at the same radial distance from the drive shaft as the pull track and the push track, respectively.

### BACKGROUND

The disclosed embodiments concern a permanent magnet motor.

Work is conducted worldwide to find a simple and proper solution to the object of providing motion with lowest possible loss, with the origin of pull and push forces from magnets.

On YouTube, several solutions with permanent magnet motors can be found, which produce a rotational movement, e.g. as shown in US 2006273666 A1 and US 20100148610 A1. However, the solutions described there appear to loose substantial power during transition from forward and backward motion in the rotating system:

a) in that the magnets obtain unfortunate inclined positions,

b) in that the magnets must pass other magnets,

c) in that the magnets cannot perform what they are supposed to do, i.e. just push and pull without any unfortunate acceleration and retardation forces,

d) in that it is not possible to obtain a powerful 360 degrees tangential torque.

Prior art from US 2006273666 A1 shows reciprocating movements (107, 118) (126, 124), which alternatingly pull and push a piston rod (117) through two +− magnet disks (119a, 119b) attached to a rod, by a magnetic isolated intermediate plate (119). The forward and rearward movements of the magnet disks (118, 124) including rollers and rods (107, 126) will according to US 2006373666 A1 have to increase weight, but also increase the acceleration and the retardation forces at higher rotational speeds (for example 1500 o/min, which will be natural to the device). This produces 25 switching operations per second, which will become a large problem, with high vibrations even at low rotational speeds.

It seems that US 2006273666 A1 has chosen to solve this problem by applying alternative forces, such as:

Force, 1): pressurized air (109, 128)

Forge, 2): current from the mains (405a, 425a)

Force, 3): current from battery (307).

On basis of this, US 200627366 A1 is a hybrid. Impulse decays on (S1, 109) makes it doubtful whether the machine will operate at all, since there is no mechanical transmission from “drive shaft to the ignition system”. Compared to a gasoline motor/Otto motor, it has mechanical transmission from driving wheel to both cam shaft and distributor to prevent breakdown.

### SUMMARY

The disclosed permanent motor improves upon the prior art.

The particular effect obtained compared to the prior art, is that the permanent magnets of the device are attached along the periphery of inclined circular disks, which are balanced, thus lacking the large and disadvantageous acceleration and retardation forces experienced by the prior art. The principle of the device is more familiar to the rotating magnetic field in a three phase engine, which produces a powerful 360 degrees tangential torque, without the need for electricity or another form of incoming force from other units, which is the case of the device described in US 2006273666 A1.

The permanent magnet motor disclosed herein produces an outgoing rotational force without the need for assistance by electricity or another form of incoming force. The outgoing mechanical rotational force is provided by two independent rotating inclined disks with their bearings attached to a fixed hub, in a gusset/tooth engagement with a drive shaft. Around the periphery of the disks, there are mounted linear +/− permanent magnets in pairs. The push and pull forces from these magnets occur along the attachment circles. controlled by on/off-sectors in the form of arc shaped recesses in a screen amounted between the disks. The example illustrated by the drawing and described below, provides a pull sector (−) of about 90 degrees, and a diametrally located push sector (+) of about 90 degrees. In order to be able to provide a rotary field of 360, additional rotary fields at the two remaining diametral blind sectors, each exhibiting 90 degrees, must also be provided.

An example of a solution of a 360 degrees rotary field: the drive shaft is provided with another power unit with a screen, where all is rotated 90 degrees in relation to the first power unit. Hence, the two power units will together provide the device with a rotary field to the device of 360 degrees. Then, the two power units will together provide the device with a rotary field of 360 degrees, i.e. 4×90=360 degrees. In order to provide the device with even more torque, additional power units are attached to the drive shaft. Moreover, the structure of the device is suitable for mounting additional large permanent magnets to operate power generators, for electric operation of cars, propulsion to ships and airplanes, etc., without fuel, without noise and exhaust from combustion engine, without high weight, and without charging and environmental problems by battery operation. It should also be mentioned that solar energy is very area demanding. With respect to control of power requirement, including start and stop: An example of this is shown in the drawing, where fixed screens having circular on/off sector tracks for controlling magnet operation, also have a “unlockable” support to be turned around the center of the drive shaft. By turning the screen, the magnets will lose the rotary force for in the end to stop the device. By turning or lateral displacement of “parts of” screens, one must make sure that the fixed hub supporting inclined disks is not moved.

A cooling fan, flywheel and connecting element, e.g. for power generator and similar are illustrated. The mode of operation of the device can also be experienced by rotating the drive shaft. Then, it is possible to observe the reciprocating movement of the permanent magnets.

The inclined surfaces and the hub ensures that inclined disks rotate toward a smaller disk distance by magnet pulling, and diametrally larger disk distance by magnet pushing in the same direction of rotation, and with diametrally larger disk distance by magnet pushing in the same direction of rotation, and with inclined balanced disks, do together provide a practically vibration-free tangential rotary power, which tolerates high rotational speeds, and effect.

In further detail, the permanent magnet motor disclosed herein exhibits a number of permanent magnets, arranged on a rotary support, connected to a drive shaft which again is connected to a power generator or another device in need of driving force. The permanent magnet motor exhibits at least two power units in the form of a first power unit and a second power unit, mutually separated by a shielding plate, wherein each power unit exhibits

a first rotary disk and a second rotary disk opposite the first rotary disk, both attached displaceable on the drive shaft to co-rotate with the same, wherein

as stator plate is arranged between the first rotary disk and the second rotary disk, wherein each rotary disk further exhibits

a number of permanent magnet pairs consisting of a pull magnet and a push magnet, displaced radially and circumferentially in relation to the pulling magnet, said permanent magnet pairs being distributed at a constant mutual distance along the periphery of the respective rotary disk, wherein

each rotary disk exhibits

a peripheral recess forming a pull slot formed along a part of the periphery of the respective rotary disk, during rotation of the power unit, arranged to expose the pull magnets on opposing rotary disks while passing along the push slot,

a second recess forming an arc shaped push slot, formed along a part of the respective rotary disk on diametrally opposite side of the push slot, and arranged at a radially displaced position in a direction toward the drive shaft, for during rotation of the power unit to expose the push magnets on opposed rotary disks, wherein

the first rotary disk and the second rotary disk are mutually inclined along the longitudinal axis of the drive shaft, having a first point on the periphery where a magnet pair is located adjacent to each other, and with a second point on diametral opposite side of the drive shaft, where another magnet pair is arranged at a mutual distance, and wherein

the second power unit is turned about 90 degrees around the drive shaft in relation to the first power unit.

Each rotary disk exhibits a bearing housing, accommodating a bearing, arranged to rotate about the drive shaft through a hub fixedly connected to the stator plate. Moreover, each rotary disk exhibits a center hole provided with teeth, in engagement with wedge seats in the drive shaft, and exhibiting at least 6 magnet pairs.

Adjacent rotary disks are mutually inclined by an angle in the range from about 3 to about 10 degrees, particularly about 5 degrees.

Each stator plate is advantageously provided with a grip to enable the stator plate to be turned about a trace in the hub and lock it in a desired position.

The rotary disks are advantageously secured by snap rings, so that the bearing is not pulled out of and released from the hub.

### BRIEF DESCRIPTION OF THE DRAWINGS

The invention is in the following described in further details by means of drawings, where

FIG. 1 shows a side sketch of an assembly,

FIG. 2 shows a section I-I in FIG. 1,

FIG. 3 shows an enlarged section of FIG. 1,

FIG. 4 shows a magnetic shielding wall, a section II-II in FIG. 1,

FIG. 5 shows a magnetic shielding wall, a section III-III in FIG. 1 1, where a non-shielding slot system is turned 90 degrees in relation to a corresponding slot system in FIG. 4, and

FIG. 6 shows an example where the device is connected to a power generator.

### DETAILED DESCRIPTION

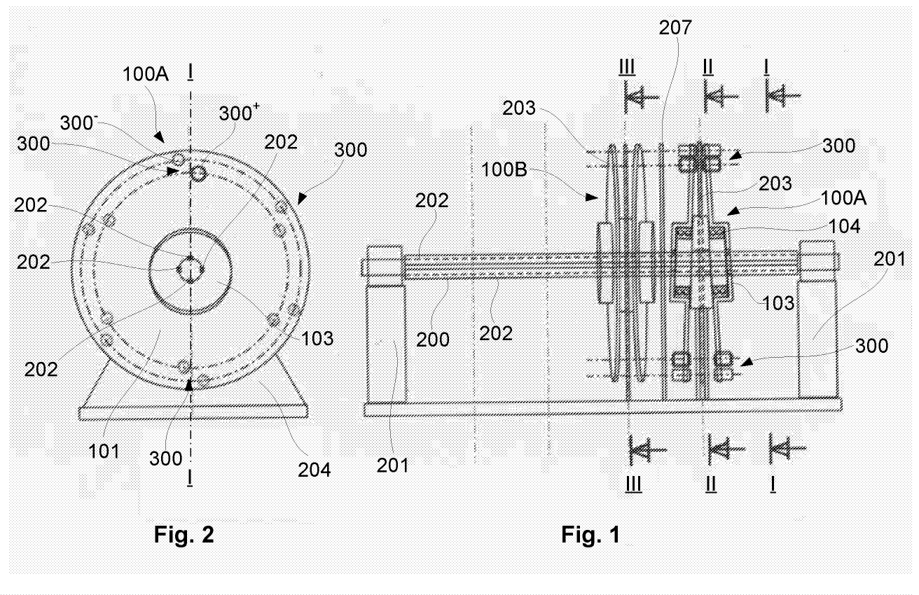

Now with reference to FIGS. 1, 2 and 3, a section is shown of a permanent magnet motor, having a first power unit 100A and a second power unit 1006, both mounted on a rotary drive shaft 200 supported in a frame 201. The first and second power unit 100A and 1006 are mutually distanced by a shielding plate 207 which prevents magnetic influence between the respective power units.

Now with reference to FIG. 1, which illustrates a section of FIG. 1 with an enlarged illustration of the first and second power unit 100A and 1006. In the illustration in FIGS. 3 (and 1), the first power unit 100A exhibits two opposed inclined rotary disks, here illustrated by a first circular rotary disk 101 and a second circular rotary disk 102. A stator 203 in the form of a plate, also denoted as notched stator plate, is provided with slits (described in further details below), wherein the first stator plate 203 is arranged between the first and second rotary disk 101 and 102. The stator plate 203 is arranged fixedly to the frame 201, perpendicular to the drive shaft 200, but can be displaced peripherally about the drive shaft 200. The stator plate does in part serve as magnetic shielding between the magnets on the adjacent rotary disks 101 and 102, and in part with its recesses in the form of pull slots 212 and push slots 213 (FIG. 5), expose magnets on the adjacent rotary disks 101 and 102 to each other. This is described further below.

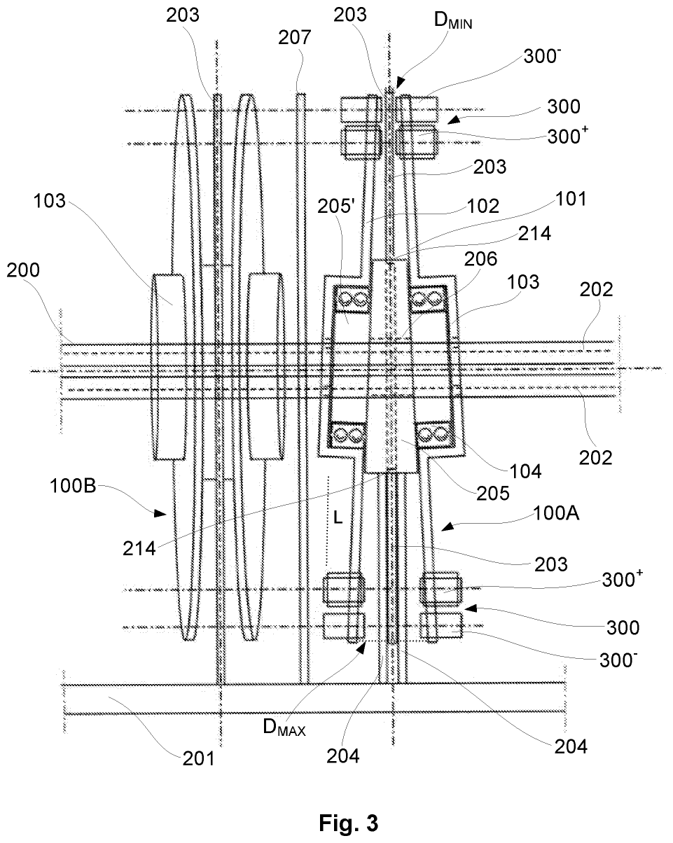

FIG. 2 shows a cross-section indicated at I-I in FIG. 1 and shows the end of the first power unit 100A, where the first rotary disk 101 is attached displaceable to the drive shaft 200 by means of wedges in the rotary disk 101, recessed in wedge seats 202 in the drive shaft 200, extending along the longitudinal axis of the same. In this way the rotary disk 101 can be forced to co-rotate along with the drive shaft 200. Two vertical dotted lines indicate the position of two additional power units.

In the illustration in FIGS. 3 (and 1), the first power unit 100A is shown in a cross-section along the drive shaft 200, whereas the second power unit 1006 for simplicity is shown in a lateral view without the details described with the first power unit 100A.

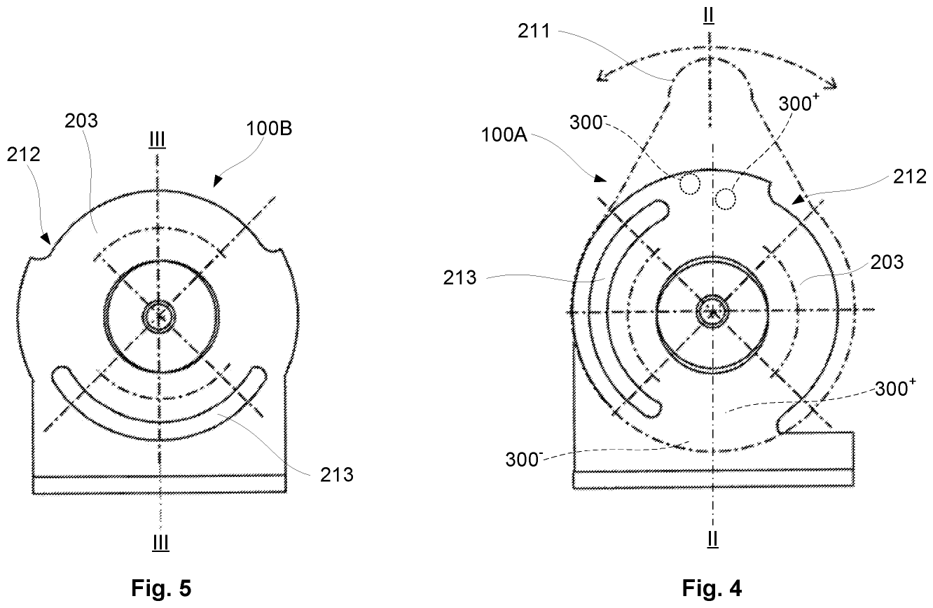

The second rotary disk 102 is formed symmetrically with the first rotary disk 101, but in a mutual inclined configuration described further below. The respective rotary disk 101, 102 each exhibits a bearing housing 103, accommodating a bearing 104, arranged to rotate about the drive shaft 200 through a hub 205, fixedly connected to the stator plate 203. The hub 205 is provided with a bore 206 through which the drive shaft 200 is extending. The bore 206 in the hub 205 has a diameter larger than the diameter of the drive shaft 200, so that the drive shaft 200 can rotate freely, independent from the hub 205 and the accompanying stator plate 203. The hub 205 and the accompanying fixed stator plate 203 are supported by the frame 201 through support means 204. However, the stator plate 203, which in part serves as shielding between magnets on adjacent rotary disks 101 and 102, can be rotated about the hub 205 and locked in a desired position by means of a lockable recess 214 in the hub 205. This is illustrated in FIGS. 4 and 5, which show the position of adjacent power units 100A and 1006, respectively. Accordingly, the first and second rotary disks 101 and 102 are arranged to rotate through contact with the bearing only. The respective bearings 104 are arranged lying on a bearing support 205′ as an axial (with respect to the drive shaft 200) extension of the hub 205 extending axially out from both sides of the same. The respective bearings 104 can either be fixedly connected to the internal of the respective bearing houses 103 and accordingly slidable towards the bearing support 205′, or can be fixedly connected to the respective bearing support 205′ and hence slidably towards the internal of the respective bearing houses 103.

The rotary disks are advantageously secured by snap rings, to prevent the bearing 104 from being pulled out and away from the hub 205.

The first and second rotary disc 101 and 102 in a rotary disk pair in a power unit 100 are arranged at a mutual angle. A shown in FIGS. 1, 2 (and 6), the rotary discs 101, 102 in the first power unit 100A are arranged with their upper peripheral edge arranged adjacent to the stator plate 203 at a mutual minimum distance, thus forming a friction free rotational configuration between the respective rotary discs 101, 102 and the stator plate 203. The diametral opposite peripheral edge of the rotary discs 101, 102 are arranged at a mutual maximum distance which is larger than the above mentioned minimum distance, thus forming a mutual inclined first rotary disc 101 and an inclined second rotary disc 102 in a power unit 100. The angle between the first and second rotary disc 101 and 102 in a rotary disc pair and the minimum distance and the maximum distance will vary by, among other things, material thickness and magnet strength (descried below), arranged at the periphery of the rotary discs. As an example, the ratio between the maximum distance D_{MAX} and the length L of the respective rotary disc 101 or 102 can be about 7.4, whereas the ratio between the minimum distance D_{MIN} and the length L of the respective rotary disc 101 or 102 can be about 20. An example of mutual angle between adjacent rotary discs 101, 102 in a rotary disc pair in a power unit 100 can be within the range of 3 to 10 degrees, e.g. about 5 degrees.

Now with particular reference to FIG. 3, the rotary disc 101 is provided with numerous permanent magnet pairs, consisting of a pull magnet 300⁻ and a push magnet 300⁺, both arranged adjacent to each other at the outer periphery of the first rotary disc 101 along each respective circular arc indicated by dotted lines. The pull magnet 300⁻ and the push magnet 300⁺ in the first permanent magnet pair 300 are somewhat mutually displaced along the circular arc (circumference) and radially with respect to the rotary shaft 200. In a similar manner, a second permanent magnet pair is arranged, consisting of a push magnet 300⁻ and a push magnet 300⁺.

FIG. 4 shows a section or side view through the line II-II in FIG. 1 of the stator plate 203. A grip 211, here illustrated by dotted lines, is formed extending out from the periphery of the stator plate 203, to enable rotation of the stator plate 203 and lock it in a desired position by means of a lockable bearing groove 201 in the hub, as described above. A peripheral recess 212 is formed along the periphery of the stator plate 203, which in the following also is denoted as pull track 212. The radial extension of the pull track 212 is sufficient to expose the pull magnets 300⁻ of the adjacent rotary discs 101 and 102, but not more than that the push magnets 300⁺ of the adjacent rotary discs 101 and 102 are shielded with respect to each other by the mass of the stator plate 203.

In a similar manner, a peripheral recess 213 is formed, which in the following also is denoted as push track 213. The radial extension of the push track 213 is sufficient to expose the pull magnets 300⁻ of the adjacent rotary discs 101 and 102, but not more than that the push magnets 300⁺ of the adjacent rotary discs 101 and 102 are shielded with respect to each other. The arc length of the pull track 212 is selected as needed, but not longer than half of the length of the circular arc minus the extension of the magnets 300⁻ and 300⁺ within a magnet pair 300. As is apparent from FIG. 2, the pull magnet 300⁻ and the push magnet 300⁺ in a magnet pair are mutually displaced within a circular arc between the same of the rotary disc 101.

Moreover, FIG. 2 shows a minimum configuration with respect to number of magnets, wherein six magnet pairs, each consisting of a push magnet 300⁻ and a pull magnet 300⁺, are mutually distanced at an equal distance along the periphery of the rotary disc 101, resulting in an angle sector between the magnet pairs of 60 degrees. This means that 2+1.5 magnets at all times are working within the pull tracks 212 and the push tracks 213. However, the number of magnets may vary with respect to the desired level of motor power. The maximum number of magnets vary with the circumference of each magnet, the presence of a shielding sleeve, the size of the device, and the size of the discs. However, a number of six magnet pairs is considered to be a minimum to make the engine to work. By choosing a number of magnet pairs win an upper limit of a range, such as 60 magnet pairs, it is possible to obtain an angle sector between adjacent magnet pairs of 6 degrees, which means that a total of 2×15 magnet pairs are working at all times.

The position of the push magnet 300⁻ and the pull magnet 300⁺ in a magnet pair of a rotary disc is illustrated by dotted lines.

FIG. 5 is a drawing similar to FIG. 4, showing the stator plate 203 in an adjacent power unit 1006, where the position of the magnets for simplicity has been omitted. Here we can see that the pull track 212 and the push track 213 are turned about 90 degrees about the periphery of the drive shaft.

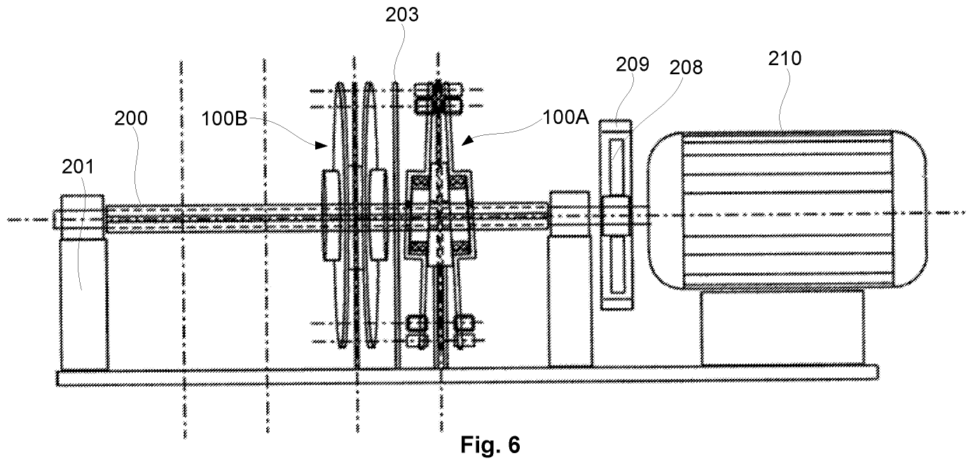

Now with reference to FIG. 6, a permanent magnet motor is shown, in a minimum configuration, having two power units 100A and 1006, and having a cooling fan 208 fixedly connected to the drive shaft 200 to be powered by the latter for production of current.

1-8. (canceled)

9. A permanent magnet motor having a plurality of permanent magnets (300−, 300+) arranged on a rotary support connected to a drive shaft (200) defining a central axis and connected to a power generator (210) or another device in need of drive force, comprising:
a first power unit (100A) and a second power unit (100B) separated from one another by a shielding plate (207), each power unit (100A, 100B) having a first rotary disc (101) and a second rotary disc (102) opposite the first rotary disc (101), each displaceably mounted on and configured to be rotate with the drive shaft (200); and
a stator plate (203) arranged between the first rotary disc (101) and the second rotary disc (102) in each of the first power unit (100A) and second power unit (100B), wherein
each rotary disc (101, 102) further includes a plurality of permanent magnet pairs (300), each permanent magnet pair (300) comprising a pull magnet (300−) and a push magnet (300+) displaced radially and circumferentially relative to one another, each said permanent magnet pair (300) being circumferentially distributed at a mutual equal distance along the respective rotary disc (101, 102),
each rotary disc (101, 102) further includes a peripheral recess forming a pull track (212) formed along a portion of the periphery of the respective rotary disk (101, 102), the pull track (212) configured to expose the pull magnets (300−) on opposing rotary discs (101, 102) passing along the pull track (212) during rotation of the power unit,
each rotary disc (101, 102) further includes a second recess forming an arc shaped push track (213) formed along a part of the respective rotary disc (101, 102) at a circumferential position diametrically opposite from the push track (213) of the respective rotary disc, and a radially inwardly displaced relative to the pull track (212) configured to expose the push magnets (300+) on opposed rotary discs (101, 102) passing along the push track (213) during rotation of the power unit,
the first rotary disc (101) and the second rotary disc (102) of each power unit (100A) and (100B) is mutually inclined along the longitudinal axis of the drive shaft (200), with first position along the periphery wherein a magnet pair (300) on the first rotary disc (101) adjacent a magnet pair (300) on the second rotary disc (102), and a second position diametrically opposite the first position wherein another magnet pair (300) is positioned, and
the second power unit (100B) is circumferentially displaced relative to the first power unit (100A) approximately 90 degrees.

10. The permanent magnet motor of claim 9, wherein each rotary disc (101, 102) has a bearing housing (103) accommodating a bearing (104) configured to rotate about the drive shaft (200) through a hub (205) fixedly connected to the stator plate (203).

11. The permanent magnet motor of claim 10, wherein each rotary disc (101, 102) further comprises a central bore provided with teeth that engage wedge seats (202) in the drive shaft (200).

12. The permanent magnet motor of claim 9, wherein each rotary disc (101, 102) further comprises a central bore provided with teeth that engage wedge seats (202) in the drive shaft (200).

13. The permanent magnet motor of claim 9, wherein each rotary disk (101, 102) has at least 6 magnet pairs (300).

14. The permanent magnet motor of claim 9, wherein adjacent rotary discs (101, 102) of each power unit (100A, 100B) are mutually inclined by an angle within an approximate range of 3-10 degrees.

15. The permanent magnet motor of claim 14, wherein adjacent rotary discs (101, 102) of each power unit (100A, 100B) are mutually inclined by an angle of approximately 5 degrees.

16. The permanent magnet motor of claim 9, wherein each stator plate (203) comprises a grip (211) for initiating rotation of the stator plate (203) about a groove (214) in the hub (205), and locking the stator plate (203) in a desired position.

17. The permanent magnet motor of claim 10, wherein the rotary discs are secured by snap rings, which thereby prevent the bearing (104) from being pulled out and loosened from the hub (205).

18. The permanent magnet motor of claim 10, wherein adjacent rotary discs (101, 102) of each power unit (100A, 100B) are mutually inclined by an angle within an approximate range of 3-10 degrees.

19. The permanent magnet motor of claim 10, wherein each stator plate (203) comprises a grip (211) for initiating rotation of the stator plate (203) about a groove (214) in the hub (205), and locking the stator plate (203) in a desired position.

20. The permanent magnet motor of claim 11, wherein each stator plate (203) comprises a grip (211) for initiating rotation of the stator plate (203) about a groove (214) in the hub (205), and locking the stator plate (203) in a desired position.

21. The permanent magnet motor of claim 10, wherein each rotary disk (101, 102) has at least 6 magnet pairs (300).

22. The permanent magnet motor of claim 11, wherein each rotary disk (101, 102) has at least 6 magnet pairs (300).

23. The permanent magnet motor of claim 13, wherein adjacent rotary discs (101, 102) of each power unit (100A, 100B) are mutually inclined by an angle within an approximate range of 3-10 degrees.

24. The permanent magnet motor of claim 23, wherein each stator plate (203) comprises a grip (211) for initiating rotation of the stator plate (203) about a groove (214) in the hub (205), and locking the stator plate (203) in a desired position.

25. The permanent magnet motor of claim 14, wherein each stator plate (203) comprises a grip (211) for initiating rotation of the stator plate (203) about a groove (214) in the hub (205), and locking the stator plate (203) in a desired position.

26. The permanent magnet motor of claim 16, wherein the rotary discs are secured by snap rings, which thereby prevent the bearing (104) from being pulled out and loosened from the hub (205).
